(19) United States
(12) Patent Application Publication
(10) Pub. No.: US 2006/0070482 A1
(43) Pub. Date: Apr. 6, 2006

(54) Control lever with rotary wheel

(75) Inventor: Micah Yates Steele, Reinbeck, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 10/951,159

(22) Filed: Sep. 27, 2004

(51) Int. Cl. G05G 1/04

(52) U.S. Cl. 74/523

(57) ABSTRACT

A control lever assembly includes a knob mounted on a lever, a wheel rotatably mounted in an upper portion of the knob, and a rotary encoder coupled to the wheel. The knob has a housing with an opening which extends part way into a side wall and a top wall thereof. Part of the wheel top surface and side surface are exposed through the opening. The wheel has a rotation axis which is generally parallel to a main axis of the lever. An inner housing attached to the lever encloses a portion of the encoder, and the inner housing is enclosed by the knob housing. The knob housing is releasably attached to the inner housing in a snap-fit manner.

### BACKGROUND

The present invention relates to a control lever mechanism, such as a speed control lever for an infinitely variable transmission (IVT).

Production John Deere 20 Series tractors with an IVT include a speed control lever with a rotary wheel, and such a control lever assembly for an IVT is described in U.S. Pat. No. 6,404,187, issued in 2002 to Dieter Ruckert. In this control lever assembly, the rotary wheel projects laterally from a side of the housing and is rotatable about a substantially horizontal axis which is transverse with respect to an axis of the lever. Most of the wheel is exposed and outside of the housing on which it is mounted. The housing must be large enough to allow an operator's hand to grip the housing in the area below the wheel and so that the operator's thumb can manipulate the wheel. But, such a large control lever assembly will be too large for use in more compact control modules, such as an armrest control console.

It is desired to have a knob/wheel design wherein only a portion of the wheel is exposed, thus, reducing the likelihood of an accidental manipulation of the wheel. It would also be desirable to use some existing production parts or components in the design, thus limiting the number of redesigned parts. It would also be desirable to have the wheel position sensor enclosed within a knob housing so as to avoid modifying other parts in order to locate the sensor elsewhere.

### SUMMARY

Accordingly, an object of this invention is to provide a compact control lever assembly which includes a rotatable wheel coupled to a sensor.

A further object of the invention is to provide such a control lever assembly which can be used in an armrest control console.

A further object of the invention is to provide such a control lever assembly which reduces the likelihood of an accidental manipulation of the wheel.

A further object of the invention is to provide such a control lever assembly which utilizes existing production parts or components, thus limiting the number of redesigned parts.

A further object of the invention is to provide such a control lever assembly wherein a wheel position sensor is enclosed within a knob housing so as to avoid modifying other parts in order to locate the sensor elsewhere.

These and other objects are achieved by the present invention, wherein a control lever assembly has a moveable lever and a knob mounted on an end of the lever. The knob has a hollow housing which is removably attached to a cylindrical base. The housing has a cylindrical side wall which forms an opening which extends into a top portion of the housing. A wheel is coupled to rotary encoder and both are enclosed in the housing. The wheel rotates about an axis which is parallel to an axis of the lever. A portion of the side and the top of the wheel are exposed through the opening.

### BRIEF DESCRIPTION OF THE DRAWINGS

FIG. 1 is a perspective view of a portion of a vehicle armrest control panel with a lever knob assembly according to the present invention;

FIG. 2 is a perspective exploded view of the knob assembly of FIG. 1;

FIG. 3 is a perspective exploded view of the outer housing of FIGS. 1 and 2; and

FIG. 4 is another perspective view of the lever knob assembly of FIG. 1.

### DETAILED DESCRIPTION

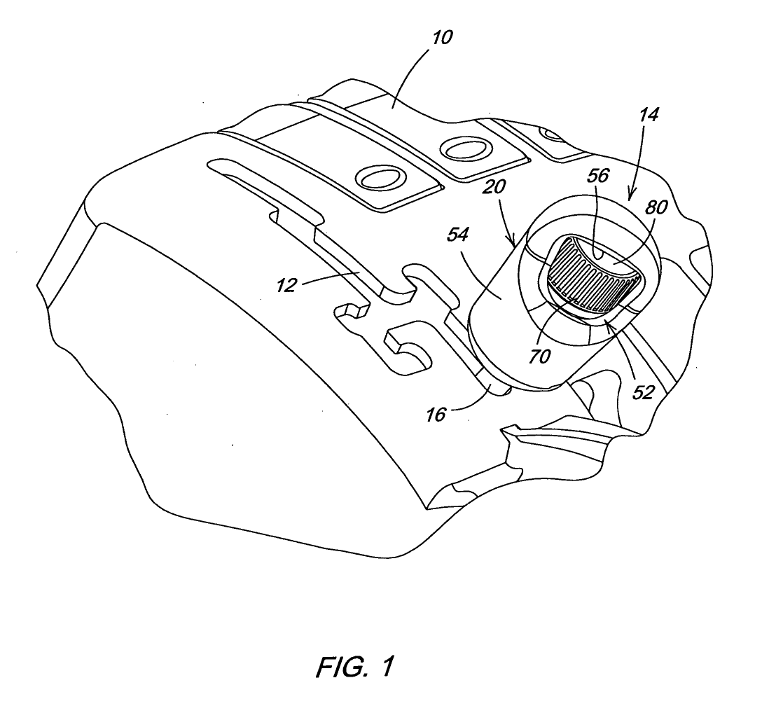

Referring to FIG. 1, an armrest control panel housing 10 includes a conventional guide slot 12 which receives a control lever unit 14, such as a control lever for an infinitely variable transmission (IVT) (not shown). Lever unit 14 has a shaft 16 which has a lower end (not shown) which is pivotally supported in a known manner with respect to the housing 10.

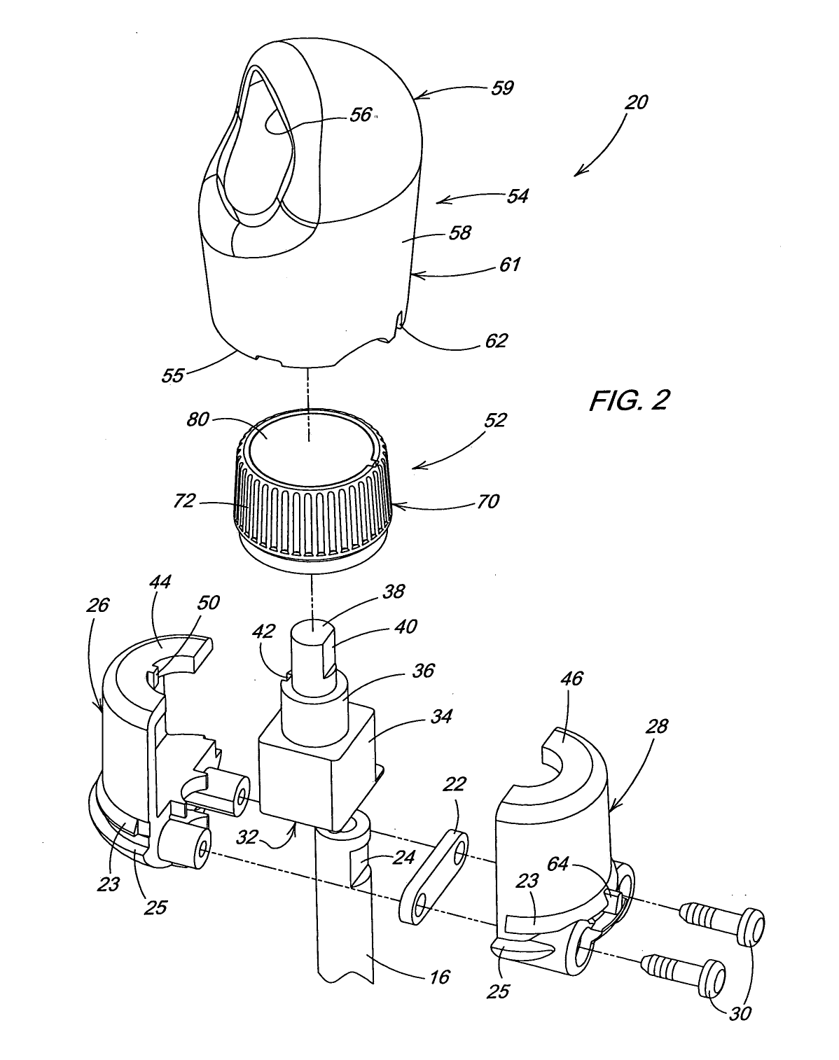

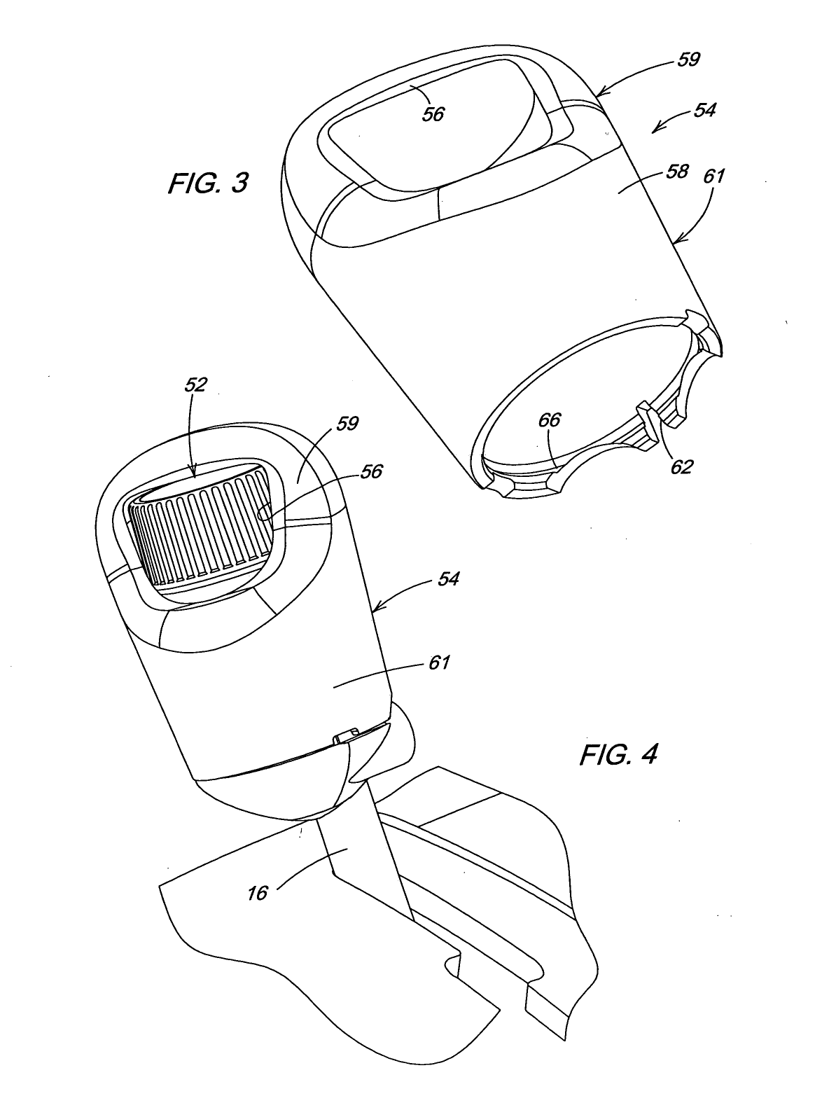

A knob assembly 20, according to the present invention is mounted to the upper end of the shaft 16. Referring now to FIGS. 1 and 2, knob assembly 20 includes an alignment member 22 which is received in a slot 24 which extends across the shaft 16 near the upper end thereof. Assembly 20 also includes inner housing pieces 26 and 28 which are attached to each other, to member 22 and thus to shaft 16 by a pair of screws 30. Inner housing pieces 26, 28 enclose a conventional commercially available optical rotary position encoder 32. Pieces 26, 28 form an annular projection or rib 23 and a shoulder 25.

Encoder 32 has box-shaped case 34 and a cylindrical sleeve 36 from which extends a rotatable sensing shaft 38 with a flat surface 40. A key slot 42 is formed on one side of sleeve 36. The upper ends 44, 46 of the inner housing pieces 26, 28 form an opening 48 through which extends the shaft 38. A tab 50 projects from end 44 and is received by slot 42 to prevent the case 34 from rotating with respect to the housing pieces 26, 28.

A wheel assembly 52 is coupled to shaft 38 of encoder 32. Preferably, the wheel assembly 52 and the encoder 32 are the same as the wheel assembly and sensor/encoder of U.S. Pat. No. 6,404,187, except that in the present invention the wheel 52 and encoder have their axes oriented parallel to a longitudinal axis of lever shaft 16. Wheel assembly 52 includes a generally cylindrical hollow wheel 70 with a knurled outer surface 72 and a slightly tapered outer profile. An end cap 80 is received in the upper end of wheel 70. The wheel 70 and end cap 80 form a top surface which faces away from the lever shaft 16.

An outer housing 54 is mounted over the wheel assembly 52 and the inner housing pieces 26, 28. Housing 54 is hollow and is fully open at its lower end 55. An opening 56 is formed in the upper portion of housing 54, and extends into a sidewall 58 and a top wall 60 of the outer housing 54. A slot 62 in the lower end 55 receives a tab 64 which projects from an outer portion of inner housing piece 28 to prevent relative rotation between outer housing 54 and inner housing pieces 26, 28. An annular groove 66 on the lower inner surface of sidewall 58 releasably receives rib 23 of the pieces 26, 28 in a snap-fit manner, and the lower end of side wall 58 engages shoulder 25 of pieces 26, 28. As best seen in FIG. 4, the housing 54 includes an upper portion 59 which contains the opening 56 and a lower portion 61 which extends from upper portion 59 to the lower end 55 of housing 54. Preferably, in the axial direction, the length of lower portion 61 is as least as long as or longer than upper portion 59. This provides ample space for an operator to grasp the lower portion 61 without inadvertently contacting the wheel 70. Yet, an operator can easily move a thumb or finger upwardly to manipulate wheel 70.

Referring again to FIG. 1, when assembled in the housing 54, a portion of the wheel assembly 52 is exposed and accessible through the opening 56. In particular, a portion of the top edge of wheel 70 and a portion of end cap 80 is exposed, and slightly less than half (in angular extent) of the outer side surface of wheel 70 is exposed.

Thus, with this design, an operator can rest his or her hand on the surface of the armrest 10 and grasp the portion of housing 54 below the opening 52 and move the lever unit 14 within the slot 12, which reduces the likelihood of an accidental manipulation of wheel 70. This design also uses some parts which are the same as previous production parts, thus limiting the number of redesigned parts. This design keeps the encoder within the outer knob housing and avoids modifying other parts in order to locate the encoder elsewhere.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. In a control lever assembly having a lever, a knob mounted on an end of the lever, a wheel rotatably mounted on the knob, and a rotary encoder coupled to the wheel, the improvement wherein:
the knob includes a hollow knob housing having a side wall and a top wall joined to and enclosing one end of the side wall, the housing having an opening therein which extends part way into the side wall and the top wall; and
the wheel is received in the knob housing for rotation therein, the wheel having a top surface facing away from the end of the lever and a generally cylindrical side surface, a portion of the wheel top surface and side surface being exposed through said opening.

2. The control lever assembly of claim 1, wherein:
the knob housing includes an upper portion which contains the opening and a lower portion which extends from the upper portion to a lower end of the knob housing, and in an axial direction, the lower portion is longer than the upper portion.

3. The control lever assembly of claim 1, further comprising:
an inner housing attached to an end of the lever and enclosing a portion of the encoder, the inner housing being enclosed by the knob housing.

4. The control lever assembly of claim 3, wherein:
the knob housing is releasably attached to the inner housing.

5. The control lever assembly of claim 3, wherein:
the knob housing is releasably attached to the inner housing in a snap-fit manner.

6. The control lever assembly of claim 3, wherein:
the inner housing comprises a first housing part and a second housing part clamped together and to the end of the lever.

7. In a control lever assembly having a lever, a knob mounted on an end of the lever, a wheel rotatably mounted on the knob, and a rotary encoder coupled to the wheel, the improvement wherein:
the knob includes a hollow knob housing having a side wall and a top wall joined to and enclosing one end of the side wall, the housing having an opening therein which extends part way into the side wall and the top wall, the knob housing including an upper portion which contains the opening and a lower portion which extends from the upper portion to a lower end of the knob housing, and in an axial direction, the lower portion is longer than the upper portion;
an inner housing is attached to an end of the lever and encloses a portion of the encoder, the inner housing being enclosed by the knob housing; and
the wheel is received in the knob housing for rotation therein, the wheel having a top surface facing away from the end of the lever and a generally cylindrical side surface, a portion of the wheel top surface and side surface being exposed through said opening.

8. The control lever assembly of claim 7, wherein:
the knob housing is releasably attached to the inner housing.

9. The control lever assembly of claim 7, wherein:
the knob housing is releasably attached to the inner housing in a snap-fit manner.

10. The control lever assembly of claim 7, wherein:
the inner housing comprises a first housing part and a second housing part clamped together and to the end of the lever.
